(19) United States
(12) Patent Application Publication
(10) Pub. No.: US 2013/0022250 A1
(43) Pub. Date: Jan. 24, 2013

(54) METHOD AND SYSTEM FOR INSPECTING DOSAGE FORMS HAVING CODE IMPRINTS USING CHEMICAL IMAGING AND SORTING THE INSPECTED DOSAGE FORMS

(71) Applicant: Gll Acquisition, LLC dba General Inspection, LLC, Davisburg, MI (US)

(72) Inventors: Michael G. Nygaard, Fenton, MI (US); David A. Strickland, Davisburg, MI (US); Christopher C. Fleming, Howell, MI (US)

(73) Assignee: GII ACQUISITION, LLC DBA GENERAL INSPECTION, LLC, Davisburg, MI (US)

(21) Appl. No.: 13/624,156

(22) Filed: Sep. 21, 2012

Related U.S. Application Data
(63) Continuation-in-part of application No. 13/240,364, filed on Sep. 22, 2011.
Application No. 13/240,364 is a continuation-in-part of application No. 13/109,393, filed on May 17, 2011.

(51) Int. Cl. G06K 9/46

(52) U.S. Cl. 382/128

(57) ABSTRACT

Method and system for inspecting dosage forms having code imprints using chemical imaging and sorting the inspected dosage forms are provided. The method includes providing reference data obtained by chemically imaging a first surface of a reference dosage form having a known good code imprint and having a known desired chemical composition. The method further includes consecutively feeding and transferring unpackaged dosage forms having code imprints and random orientations so that the dosage forms travel through a chemical composition station where a first surface of each dosage form is viewable. The method still further includes chemically imaging the first surface of each dosage form located at the chemical composition station to obtain a first set of chemical imaging data. The method further includes processing the chemical imaging data and the reference data to detect inspected dosage forms having chemical compositions different from the desired chemical composition.

### CROSS-REFERENCE TO RELATED APPLICATIONS

This application is a continuation-in-part application of Ser. No. 13/240,364 entitled “Method and System for Inspecting Dosage Forms Having Code Imprints and Sorting the Inspected Dosage Forms” filed on Sep. 22, 2011 which, in turn, is a continuation-in-part application of Ser. No. 13/109,393 entitled “Method and System for Inspecting Small Manufactured Objects at a Plurality of Inspection Stations and Sorting the Inspected Objects” filed on May 17, 2011.

### TECHNICAL FIELD OF THE INVENTION

This invention relates in general to the field of the non-contact, non-destructive inspection of manufactured dosage forms having code imprints and sorting the inspected dosage forms and, more particularly, to methods and systems for inspecting unpackaged dosage forms having code imprints using chemical or spectroscopic imaging and sorting the inspected dosage forms.

### Overview

21 C.F.R. §206 is entitled “Imprinting of Solid Oral Dosage Form Drug Products for Human Use.” Such drug products include prescription drug products, over-the-counter drug products, biological drug products, and homeopathic drug products, unless otherwise exempted under 21 C.F.R. §206.7.

A “drug product” is defined to mean a finished dosage form, e.g., a tablet or capsule that contains a drug substance, generally, but not necessarily, in association with one or more other ingredients.

A “solid oral dosage form” is defined to mean capsules, tablets, or similar drug products intended for oral use.

Unless exempted under 21 C.F.R. §206.7, no drug product in solid oral dosage form may be introduced or delivered for introduction into interstate commerce unless it is clearly marked or imprinted with a code imprint that, in conjunction with the product's size, shape, and color, permits the unique identification of the drug product and the manufacturer or distributor of the product. Inclusion of a letter or number in the imprint, while not required, is encouraged as a more effective means of identification than a symbol or logo by itself.

A “code imprint” is defined to mean any single letter or number or any combination of letters and numbers, including, e.g. words, company name, and National Drug Code, or a mark, symbol, logo, or monogram, or a combination of letters, numbers, and marks or symbols, assigned by a drug firm to a specific drug product.

“Imprinted” is defined to mean marked with an identification code by means of embossing, debossing, engraving, or printing with ink.

“Embossed” is defined to mean imprinted with a mark raised above the dosage form surface.

“Debossed” is defined to mean imprinted with a mark below the dosage form surface.

“Engraved” is defined to mean imprinted with a code that is cut into the dosage form surface after it has been completed.

Traditional manual inspecting devices and techniques have been replaced to some extent by automated inspection methods and systems. However, such automated inspection methods and systems still have a number of shortcomings associated with them.

Rapid inspection of defects on and in a variety of mass-produced dosage forms is a vital aspect in the dosage form manufacturing process, allowing for maintenance of a high level of quality and reliability in the pharmaceutical industry. For example, traditionally, quality control in the pharmaceutical industry is related to the type, purity, and amount of tablet ingredients. However, quality also relates to defects which can be detected by visual inspection such as dirt, surface blemishes, surface chips and code imprints. Although many visual inspections can be performed by operators, manual inspection can be slow, expensive and subject to operator error. Also, many types of inspections cannot be done visually. Thus, automated inspection systems for quality control in the pharmaceutical industry are extremely important. The following U.S. patent documents are related to these types of systems: U.S. Pat. Nos. 5,085,510; 4,319,269; 4,354,602; 4,644,150; 4,757,382; 5,661,249; 3,709,598; 5,695,043; 6,741,731; and 6,079,284 and U.S. published patent application 2010/0214560.

The making of medicinal tablets by compression of powders, dry or treated, is an old art and satisfactory machinery for making such tablets has long been available. FIGS. 1a and 1b illustrate such tablets. FIG. 1a shows a plurality of round tablets which are marked with an alphanumeric code imprint “BRA 200.” FIG. 1b shows a plurality of scored, oval tablets or caplets which are marked with a logo and text of a code imprint.

Rotary presses are commonly in use, in which powders or other materials that can be formed into tablets are placed into one of a plurality of generally cylindrical discs that are mounted within a rotary die holding turret. A pair of opposed cam operated punches compress the powder from both ends of each tablet forming die, and thereby compact the powder into an individual tablet. The rotary turret arrangement allows a plurality of punch and die sets to produce tablets continuously around the circular path followed by the rotary press by sequentially contacting an arrangement of cams above and below the turret that lift and lower the punches. In modern tablet press machines, pharmaceutical tablets are produced at rates as high as 12,000 tablets per minute.

It is highly desirable that all tablets prepared by rotary tablet press mechanisms be of uniform and precisely controlled size and weight. This is especially true for medicinal tablets because carefully prescribed dosage amounts are difficult to achieve without accurate tablet size and weight control. Inaccuracies in tablet size, weight and code imprints stem from a variety of different circumstances. Various different failure modes of the tablets of FIG. 1b are illustrated in FIG. 1c. Inaccuracies can also result from imperfections or wear in the tablet press or die elements, or from changes in the density or moisture content of the powder being compressed. Also, punch head defects such as partially broken or deformed punch and/or die surfaces can result in loose metal debris, such as metal chips and particles which can get into the dosage forms.

WO 2005/022076 as well as the following U.S. patents documents are related to the invention: U.S. Pat. Nos. 4,315,688; 4,598,998; 4,644,394; 4,831,251; 4,852,983; 4,906,098; 4,923,066; 5,383,021; 5,521,707; 5,568,263; 5,608,530; 5,646,724; 5,291,272; 6,055,329; 4,983,043; 3,924,953; 5,164,995; 4,721,388; 4,969,746; 5,012,117; 6,313,948; 6,285,034; 6,252,661; 6,959,108; 7,684,054; 7,403,872; 7,633,635; 7,312,607, 7,777,900; 7,633,046; 7,633,634; 7,738,121; 7,755,754; 7,738,088; 7,796,278; 7,684,054; 7,802,699; and 7,812,970; and U.S. published patent applications 2005/0174567; 2006/0236792; 2010/0245850 and 2010/0201806.

In order to fulfill the quality requirements introduced by regulatory authorities for pharmaceutical products, reliable methods are needed for the product qualification. Many process analytical technology (PAT) tools satisfy the requirements, such as non-destructive and sensitive determination of material properties.

Spectroscopic or spectral imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e., chemical) imaging typically comprise image gathering optics, focal plane array imaging detectors and imaging spectrometers.

A spectrometer or spectrograph is an instrument used to measure properties of light over a specific portion of the electromagnetic spectrum, typically used in spectroscopic analysis to identify materials. The variable measured is most often the light's intensity but could also, for instance, be the polarization state. The independent variable is usually the wavelength of the light or a unit directly proportional to the photon energy, such as wavenumber or electron volts, which has a reciprocal relationship to wavelength. A spectrometer is used in spectroscopy for producing spectral lines and measuring their wavelengths and intensities.

Near-infrared spectroscopy (NIRS) is a spectroscopic method that uses the near-infrared region of the electromagnetic spectrum (from about 800 nm to 2500 nm). Typical applications include pharmaceutical, medical diagnostics (including blood sugar and oximetry), food and agrochemical quality control, and combustion research, as well as cognitive neuroscience research.

Near-infrared spectroscopy is based on molecular overtone and combination vibrations. Such transitions are forbidden by the selection rules of quantum mechanics. As a result, the molar absorptivity in the near IR region is typically quite small. One advantage is that NIR can typically penetrate much farther into a sample than mid-infrared radiation. Near-infrared spectroscopy is, therefore, not a particularly sensitive technique, but it can be very useful in probing bulk material with little or no sample preparation.

The molecular overtone and combination bands seen in the near-IR are typically very broad, leading to complex spectra; it can be difficult to assign specific features to specific chemical components. Multivariate (multiple variables) calibration techniques (e.g., principal components analysis, partial least squares, or artificial neural networks) are often employed to extract the desired chemical information. Careful development of a set of calibration samples and application of multivariate calibration techniques is important for near-infrared analytical methods.

Instrumentation for near-IR (NIR) spectroscopy is similar to instruments for the UV-visible and mid-IR ranges. There is a source, a detector, and a dispersive element (such as a prism or a diffraction grating) to allow the intensity at different wavelengths to be recorded. Fourier transform NIR instruments using an interferometer are common, especially for wavelengths above 1000 nm. Depending on the sample, the spectrum can be measured in either reflection or transmission.

Common incandescent or quartz halogen light bulbs are most often used as broadband sources of near-infrared radiation for analytical applications. Light-emitting diodes (LEDs) are also used; they offer greater lifetime and spectral stability and reduced power requirements.

The type of detector used depends primarily on the range of wavelengths to be measured. Silicon-based CCDs are suitable for the shorter end of the NIR range, but are not sufficiently sensitive over most of the range (over 1000 nm). InGaAs and PbS devices are more suitable though less sensitive than CCDs. In certain diode array (DA) NIRS instruments, both silicon-based and InGaAs detectors are employed in the same instrument. Such instruments can record both UV-visible and NIR spectra ‘simultaneously.’

Instruments intended for chemical imaging in the NIR may use a 2D array detector with an acoustic-optic tunable filter. Multiple images may be recorded sequentially at different narrow wavelength bands.

Many commercial instruments for UV/vis spectroscopy are capable of recording spectra in the NIR range (to perhaps ˜900 nm). In the same way, the range of some mid-IR instruments may extend into the NIR. In these instruments, the detector used for the NIR wavelengths is often the same detector used for the instrument's “main” range of interest.

Transmission Raman spectroscopy is a variant of Raman spectroscopy beneficial in probing bulk content of diffusely scattering samples. Transmission Raman lends itself to rapid, non-invasive and non-destructive analysis of pharmaceutical dosage forms such as capsules and tablets. This addresses several limitations of traditional pharmaceutical assay techniques including limitations due to surface sensitivity (e.g., reflectance NIR), the presence of phase changes due to sample preparation (liquid chromatography) or sub-sampling (conventional Raman, NIR). Transmission Raman is largely insensitive to surface, requires no sample preparation, involves no phase change and is rapid. Transmission Raman spectroscopy of pharmaceutical tablets and capsules has been demonstrated and the technique's accuracy and applicability has been established to quantify tablet and production-style capsule formulations.

Pharmaceutical tablets and capsules are typically composed of a combination of APIs and excipients, each of which will produce a Raman spectral component with a relative intensity proportional to the ingredient concentrations. Analyzing Raman spectra to produce assay results requires a method to separate the individual spectral components and correlate their intensity contributions with a relative concentration measure. This is typically facilitated using chemometric analysis methods such as described in U.S. patent publication 2009/0244533.

NIR measuring devices are disclosed in U.S. patent documents U.S. Pat. No. 7,294,837 and 2009/0026373.

Both NIR dielectric and Raman spectrometers together with standard chemometric techniques for analyzing spectroscopic data are disclosed in U.S. Pat. No. 7,930,064.

U.S. Pat. No. 6,690,464 discloses a method and system for testing packaged pharmaceutical dosage units using continuous spectral imaging techniques.

U.S. Pat. Nos. 6,667,802; 6,765,212; 6,771,369; 6,853,447; 6,894,772; 6,954,271; 7,006,214; and 7,317,525 disclose a wide variety of methods and systems including spectrometers and reflective data analysis.

A near-infrared (NIR) spectral imaging system entitled Helios is available from EVK DI Kerschhaggl GmbH. The system includes an InGaAs detector. Multivariate data analysis (MVDA) is applied for qualitative and quantitative characterization.

The Helios system uses an adjustable halogen lamp as an IR source. The system works in reflectance. Reflected IR rays pass an objective lens and an adjustable aperture in order to get the optimal resolution and depth of focus. The following built-in spectrograph includes a prism/grating/prism (prism spectrophotopolarimeter—PSP) assembly and additional lenses. With this optical component, light is dispersed, causing a spectral separation of the linear spatial image. Hence, for each spatial position scanned, individual spectra are projected on the plane detector or sensor, making the Helios system a multichannel spectrometer with a so-called push-broom technology. U.S. Pat. No. 6,853,447 discloses a push-broom scanning spectrometer. The Helios system has also the potential to be extended with a multi-fiber device, where different positions can be investigated simultaneously.

### SUMMARY OF EXAMPLE EMBODIMENTS

In a method embodiment, a method of inspecting dosage forms having code imprints and sorting the inspected dosage forms is provided. The method includes providing reference data including a first set of reference data obtained by chemically imaging a first surface of a reference dosage form having a known good code imprint on the first surface and having a known desired chemical composition. The method further includes consecutively feeding and transferring unpackaged dosage forms having code imprints and random orientations so that the dosage forms travel on a path which extend from a dosage form loading station and through at least one inspection station including a chemical composition station where a first surface of each dosage form is viewable at the chemical composition station. The method still further includes chemically imaging the first surface of each dosage form located at the chemical composition station to obtain a first set of chemical imaging data. The method further includes processing the chemical imaging data and the reference data including the first set of reference data to detect inspected dosage forms having chemical compositions different from the desired chemical composition. The method still further includes sorting the inspected dosage forms based on the at least one inspection at the at least one inspection station.

The inspected dosage forms may be solid dosage forms intended for oral use, such as tablets.

The inspected dosage forms may be imprinted by at least one of embossing, debossing, engraving and imprinting with ink.

The code imprints may include an alphanumeric character.

The step of consecutively feeding and transferring may include the step of applying a vacuum to the inspected dosage forms.

Only the first surface of each inspected dosage form may be viewable at the chemical composition station.

Each dosage form to be inspected at the chemical composition station may have an unknown orientation.

A second surface of each dosage form may be viewable at a second inspection station and each dosage form to be inspected at the second inspection station may have an orientation opposite the unknown orientation at the chemical composition station.

The dosage forms may be consecutively fed and transferred in rows.

The path may include at least one curved segment.

The first surface of the reference dosage form may be chemically imaged at the chemical composition station.

The reference data may include a second set of reference data obtained by chemically imaging a second surface of the reference dosage form opposite the first surface of the reference dosage form and the second set of reference data is processed during the step of processing.

The second surface of the reference dosage form may be chemically imaged at the chemical composition station.

The step of sorting may include the step of directing dosage forms identified as having an unacceptable chemical composition to a defective dosage form area.

In a system embodiment, a system for inspecting dosage forms having code imprints and sorting the inspected dosage forms is provided. The system includes storage for storing reference data including a first set of reference data obtained by chemically imaging a first surface of a reference dosage form having a known good code imprint on the first surface and having a known desired chemical composition. The system further includes a feeder and transfer subsystem to consecutively feed and transfer unpackaged dosage forms having code imprints and random orientations so that the dosage forms travel on a path which extend from a dosage form loading station and through at least one inspection station including a chemical composition station where a first surface of each dosage form is viewable at the chemical composition station. The system still further includes a chemical imaging assembly to chemically image the first surface of each dosage form located at the chemical composition station to obtain a first set of chemical imaging data. The system further includes at least one processor to process the chemical imaging data and the reference data including the first set of reference data to detect inspected dosage forms having chemical compositions different from the desired chemical composition. The system still further includes at least one dosage form sorter to sort the inspected dosage forms based on the at least one inspection at the at least one inspection station. The system further includes a system controller coupled to the subsystem, the imaging assembly, the at least one processor and the at least one dosage form sorter for controlling the sorting based on the at least one inspection.

The inspected dosage forms may be solid dosage forms intended for oral use, such as tablets.

The inspected dosage forms may be imprinted by at least one of embossing, debossing, engraving and imprinting with ink.

The code imprints may include an alphanumeric character.

Only the first surface of each inspected dosage form may be viewable at the chemical composition station.

Each dosage form to be inspected at the chemical composition station may have an unknown orientation.

A second surface of each dosage form may be viewable at a second inspection station and each dosage form to be inspected at the second inspection station may have an orientation opposite the unknown orientation at the chemical composition station.

The dosage forms may be consecutively fed and transferred in rows.

The path may include at least one curved segment.

The first surface of the reference dosage form may be chemically imaged at the chemical composition station.

The reference data may include a second set of reference data obtained by chemically imaging a second surface of the reference dosage form opposite the first surface of the reference dosage form and the second set of reference data is processed by the processor.

The second surface of the reference dosage form may be chemically imaged at the chemical composition station.

The subsystem may include a vibration transfer plate having a plurality of spaced apart grooves for moving lines of the dosage forms along the path.

The subsystem may include at least one vacuum transfer device for conveying rows of the dosage forms at equal intervals to the chemical composition station.

The at least one dosage form sorter may direct dosage forms identified as having an unacceptable chemical composition to a defective dosage form area.

Other technical advantages will be readily apparent to one skilled in the art from the following figures, descriptions and claims. Moreover, while specific advantages have been enumerated, various embodiments may include all, some of or none of the enumerated advantages.

### BRIEF DESCRIPTION OF THE DRAWINGS

For a more complete understanding of the present invention, and for further features and advantages thereof, reference is made to the following description taken in conjunction with the accompanying drawings, in which:

FIG. 1a is a schematic perspective view of a plurality of round or disk-shaped tablets, each of which has an alphanumeric code imprint and which can be inspected and sorted utilizing at least one embodiment of the present invention;

FIG. 1b is a schematic perspective view of a plurality of scored, oval tablets, each of which has a code imprint and which can be inspected and sorted utilizing at least one embodiment of the present invention;

FIG. 1c is a schematic perspective view of three of the tablets of FIG. 1b wherein one of the tablets has a “capping” failure and a defective code imprint, one of the tables has a lamination failure and a nonexistent code imprint and one of the tablets is not defective (i.e. is “good”);

FIG. 2 is a block diagram schematic view of one embodiment of a system constructed in accordance with the invention and including a grooved vibration plate, a pair of synchronized vacuum, transfer drums, a pair of optical imaging assemblies located at respective inspection or vision stations, a chemical imaging assembly located at a chemical composition inspection station, and a dosage form sorter for sorting the dosage forms based on the inspections;

FIG. 3 is a block diagram schematic view, partially broken away, of a plurality of dosage form sorters (one for each circular column) located at a defective dosage form area beneath the lower vacuum transfer drum;

FIG. 4 is an exploded assembly view of one of the substantially identical vacuum transfer drums for transferring an array or rows of dosage forms such as pills or tablets;

FIG. 5 is a schematic side perspective view, partially broken away, of parts or portions of the system of FIG. 2; and

FIG. 6 is a schematic end perspective view, partially broken away, of parts or portions of the system of FIG. 5 including an infeed hopper.

### DETAILED DESCRIPTION OF EXAMPLE EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

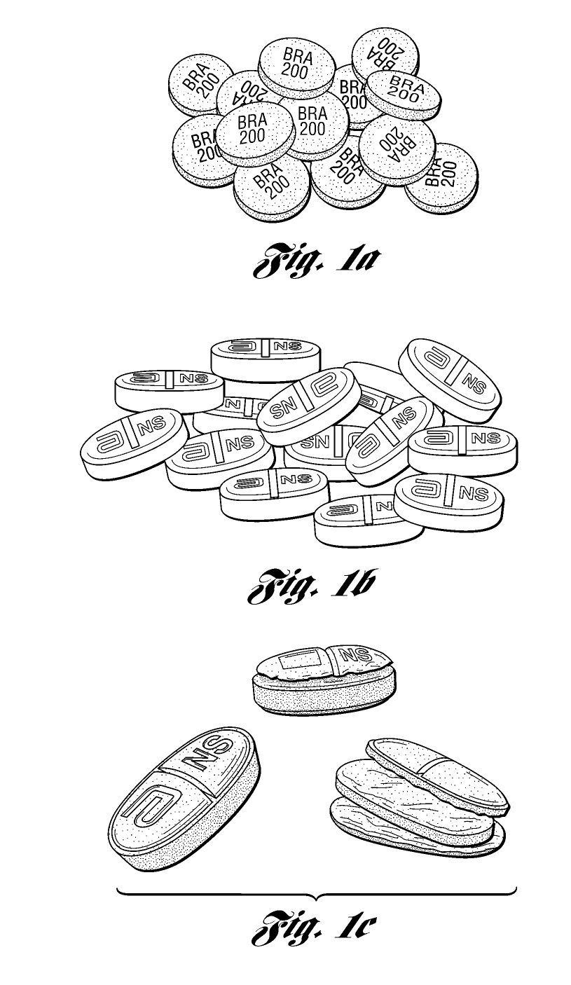

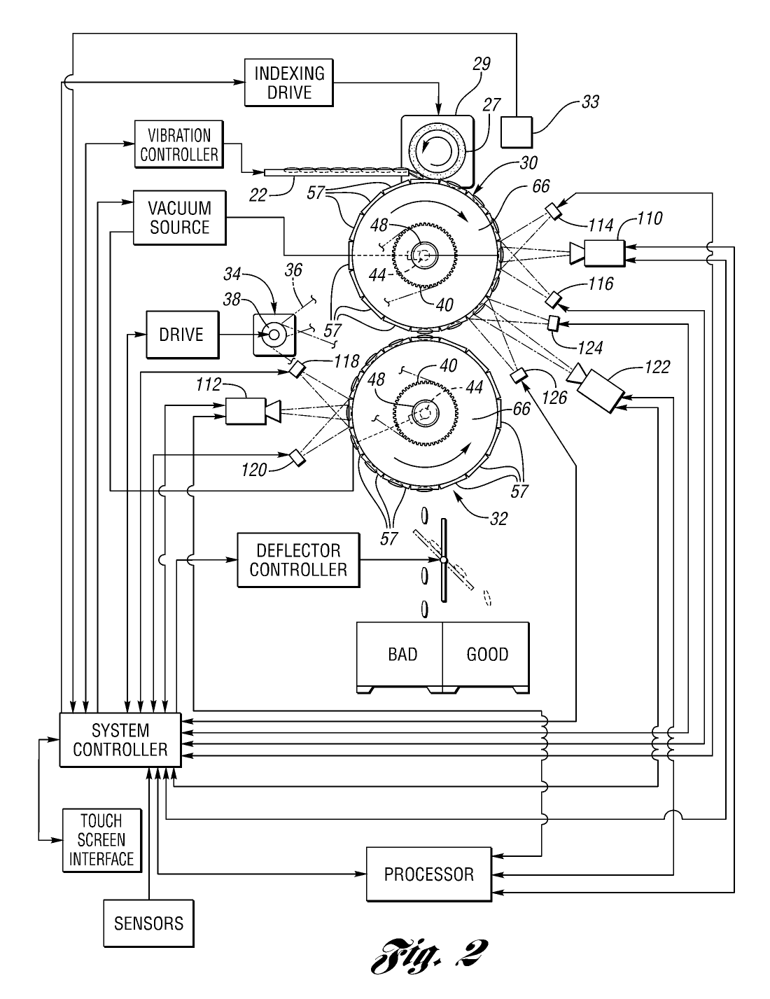

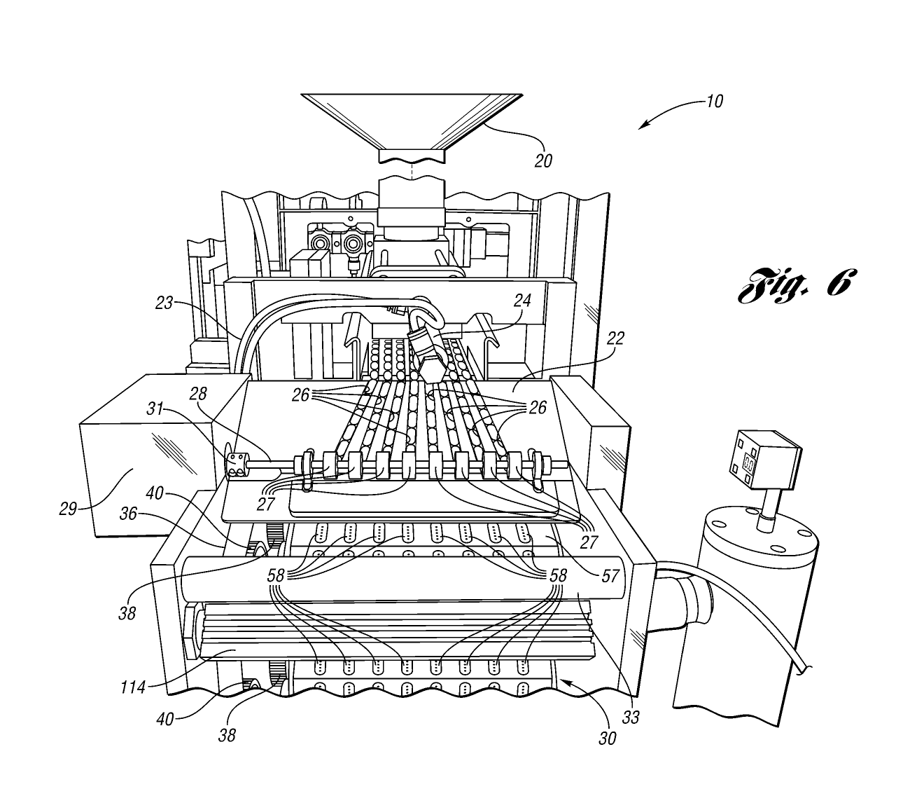

In general, one embodiment of the method and system of the present invention inspects unpackaged dosage forms such as pharmaceutical tablets and pills, some of which are illustrated in FIGS. 1a-1c and sorts the inspected dosage forms. The system, generally indicated at 10 in FIGS. 5 and 6, is a complete system designed for the inspection and sorting of the manufactured dosage forms. However, the method and system are also suitable for inspecting and sorting other similar small, mass-produced manufactured objects. The system 10 includes subsystems which may be used for dosage form handling and delivery and can vary widely from application to application depending on dosage form size and shape as well as what inspections are being conducted at the inspection stations. The subsystems or assemblies ultimately chosen for dosage form handling and delivery generally have some bearing on the nature of the subsystems or assemblies conducting at least one inspection, including chemical composition inspection by a chemical imaging assembly and at least one processor.

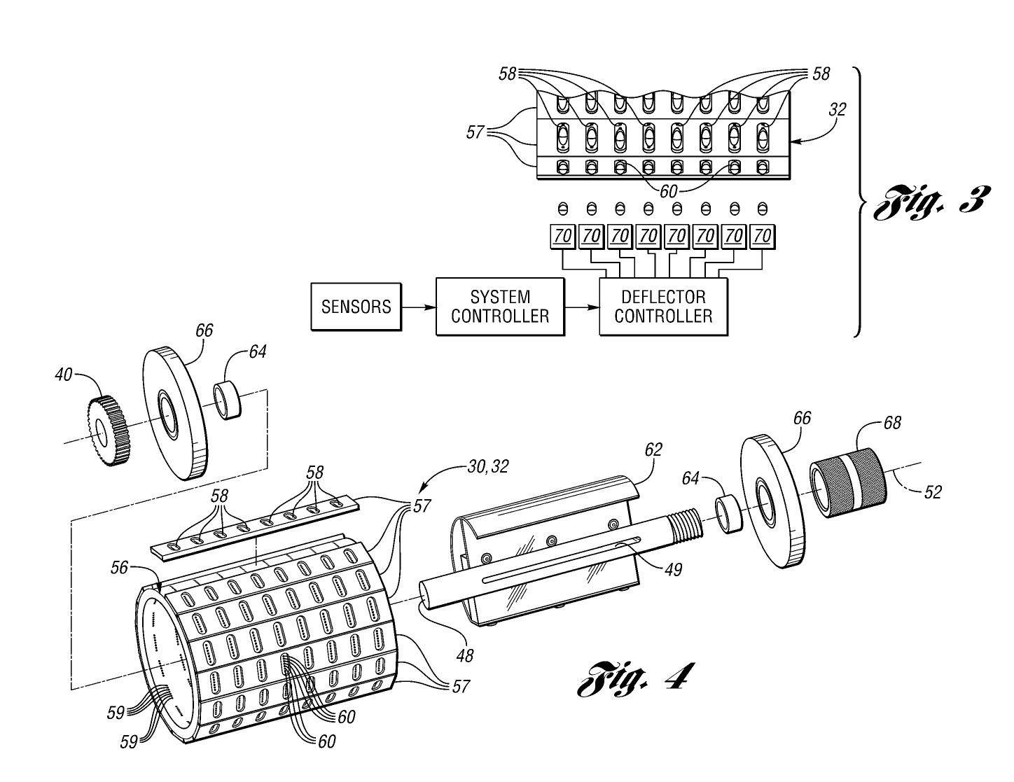

Referring now to FIGS. 2, 5 and 6, one embodiment of the system may accept dosage forms at an infeed hopper 20 (FIG. 6) at one end and automatically feed and convey the randomly orientated dosage forms in a plurality of columns or rows through a number of inspecting or inspection stations. In particular, the infeed hopper 20, a vibratory feeder unit including a grooved vibration plate 22, dosage form feed rollers 27 and vacuum operated or assisted upper and lower vacuum drums 30 and 32 feed and transfer dosage forms through at least one inspection station for high-speed automated inspection, including chemical composition inspection. It is to be understood that instead of vacuum drums 30 and 32, one or more transfer conveyors may be provided such as the vacuum transfer conveyor shown and described in co-pending application Ser. No. 13/109,393, wherein one or both sides of the dosage forms are inspected. At a high level, each of the embodiments of the system includes a feeder, a transfer subsystem and an inspection machine subsystem for conducting one or more inspections such as a chemical composition inspection. Each major subsystem features a modular design with several possible upgrades providing varying levels of chemical or spectroscopic inspection capability.

Still referring to FIGS. 2, 5 and 6, dosage forms to be sorted are initially loaded into the hopper 20 for positioning on a feeder tray (not shown) on which the dosage forms are evenly spread by a pneumatically-controlled translating escapement air cylinder or bar 24 (FIGS. 5 and 6). Air lines 23 provide periodic pneumatic control signals to the translating bar 24 from a controller (not shown) which, in turn, is controlled by a system controller. Then the tablets are conveyed and fed in spaced grooves 26 of the vibration tray or plate 22 at a controlled rate by vibration. The plate 22 has a plurality (here 8) of grooves 26 formed in an upper surface thereof to receive, retain and transfer the lines of tablets contained therein as they controllably move by vibration towards their respective feed rollers 27. Adjacent the uppermost position of the upper vacuum transfer drum 30, each tablet is fed by its respective feed roller 27 onto the outer circumferential surface of the drum 30. The spaced feed rollers 27 are drivenly mounted on a shaft 28 which is coupled to the output drive shaft of a motor or drive assembly (not shown) by a coupler 31 (FIG. 6). The drive motor or assembly is housed within a housing 29 and indexes the rollers 27 under control of an indexing driver which, in turn, is controlled by the system controller (FIG. 2).

Dosage forms are provided to the inspection machine subsystem by the vibratory feeder unit including the vibration plate and the roller subsystem at controlled, regular and, preferably, equal intervals. The inspection machine subsystem of the first embodiment is located at several inspection stations, as shown in FIGS. 2, 5 and 6, located along the path of conveyance. As the dosage forms are conveyed by the drums 30 and 32, the dosage forms pass by or through the inspection stations and are automatically inspected. Dosage forms which pass each of the inspections (have no unacceptable defects) are preferably actively accepted by their respective part diverters or flippers 70 located at the end of the path of conveyance. Alternatively, dosage forms which pass all of the inspections may be passively accepted and dosage forms which fail at least one of the inspections are actively rejected. The inspection stations located throughout the inspection machine subsystem include the first and second machine vision modular inspection stations and a chemical composition inspection station.

In general, the vibration plate 22, the rollers 27 and the upper drum 30 transfer or convey unpackaged dosage forms having random orientations so that they travel along a path which extends from the loading station to the first inspection or vision station at which the dosage forms have a predetermined position but unknown orientation for machine vision inspection. Then the upper drum 30 transfers and conveys the dosage forms after inspection at the first vision station by an upper imaging assembly (i.e. one or more high resolution cameras 110 and upper and lower illuminating devices 114 and 116, respectively) so that the inspected dosage forms travel along a curved path which extends from the first vision station to a chemical composition inspection station. Subsequently, the upper drum 30 and then the lower drum 32 transfer or convey the dosage forms after inspection at the chemical composition inspection station by a chemical imaging assembly (i.e. one or more multi or hyperspectral cameras 122 and upper and lower illuminating devices 124 and 126). The camera 122 may be an infrared or Raman spectroscopic imaging assembly such as the Helios NIR spectral imaging system. Then the inspected dosage forms travel along a curved path which extends from the chemical composition station to a second vision station for further machine vision inspection by a lower imaging assembly (i.e. one or more high resolution color cameras 112 and upper and lower illuminating devices 118 and 120, respectively). While FIGS. 2, 5 and 6 show a single camera 110 at the upper vision station and a single camera 112 at the lower vision station, a camera can be provided for each dosage form at each vision station (i.e. for example, a plurality of cameras at each vision station in FIGS. 2, 5 and 6). Also, a multispectral or hyperspectral camera may be provided for each dosage form at the chemical composition station.

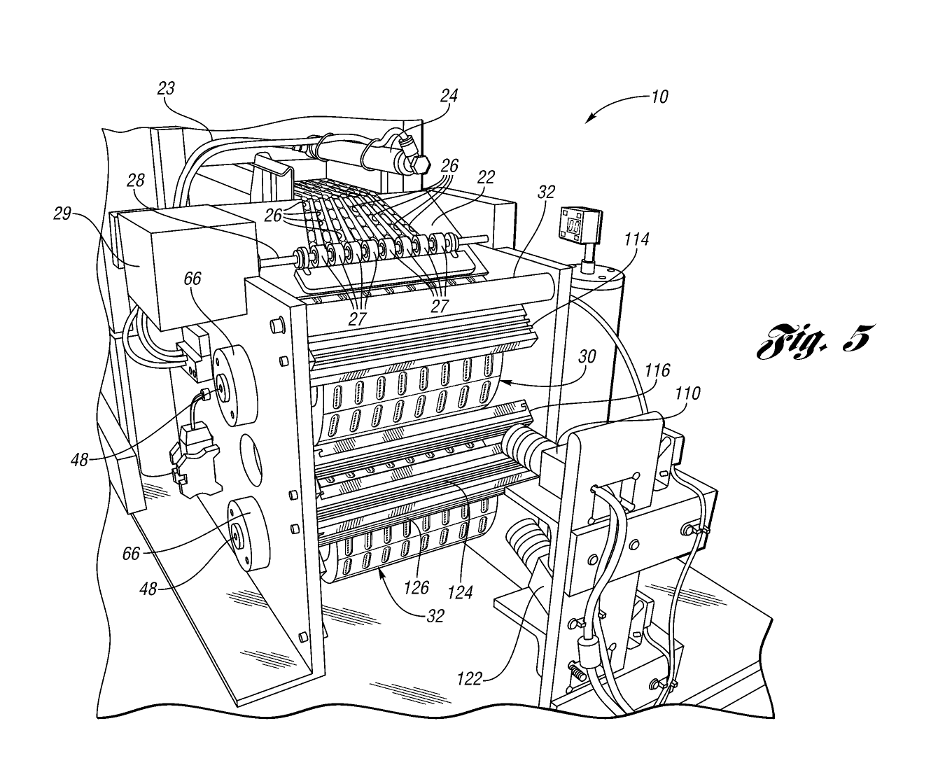

As further illustrated in FIG. 2, under control of the system controller, a controller for the vibration plate 22 controls the plate 22 based on various sensor input signals from sensors to the system controller which, in turn, provides sequential control signals to the plate controller. The system controller also provides control signals to a computer display such as a touch screen interface, dosage form sorters (for example, deflectors 70 (FIG. 3) at a sorting or reject station) to the first and second imaging assemblies at their respective vision stations and to the chemical imaging assembly at the chemical composition inspection station.

Referring now to FIG. 4, each of the drums 30 and 32 includes a sprocket 40 by which one or more belts such as a belt 36 synchronously drives the drums 30 and 32 via sprockets 38 (one shown in FIG. 2, two shown in FIG. 6) of a servomotor assembly 34 in opposite directions. The sprockets 40 are mounted on one of their respective spaced annular end caps or plates 66 to rotate therewith with their respective cylinder members 56. The cylinder members 56 and end plates 66 are rotatably supported on their respective slotted, hollow shafts 48 by spaced bearing assemblies 64. A hollow vacuum coupler 68 is threadably secured at one end of the hollow shaft 48 opposite its sprocket 40 to communicate a vacuum from a vacuum source or vacuum tube (located to the right of the drums in FIGS. 5 and 6) via a coupler 44 to the interior of its member 56 via the slot 49 formed through a side wall of the hollow shaft 48.

A stationary metal sheet 62 is secured to the shaft 48 and prevents the vacuum within the cylinder member 56 from communicating with certain holes 59 formed through the cylindrical side wall of the member 56, which, in turn, communicate with aligned holes 60 formed through strips 57 and into dosage form receiving depressions 58 in the strips 57. The holes 59 blocked by the metal sheet 62 are those holes 59 which communicate with the empty depressions 58 of the drum 30 extending clockwise from its 6 o'clock position to its 12 o'clock position at which the drum 30 picks up more dosage forms. The holes 59 of the drum 32 blocked by the metal sheet 62 are those holes which communicate with the empty depressions 58 of the drum 32 extending counterclockwise from its 6 o'clock position to its 12 o'clock position at which the drum picks up more dosage forms.

As previously mentioned, dosage forms are provided to the inspection machine subsystem by the feeder and the transfer subsystem at controlled regular and, preferably, equal intervals. The inspection machine subsystem may include several visual inspection stations, each of which includes an imaging assembly such as the camera assemblies 110 and 112, or the chemical imaging assembly 122, all shown in FIG. 2 located along the path of conveyance. As the dosage forms are conveyed by the drums 30 and 32, the dosage forms pass by the machine vision color camera assemblies 110 and 112 and by the chemical imaging assembly 122 of FIG. 2 at their respective visual and chemical composition inspection stations where the dosage forms are optically and chemically imaged and inspected. Dosage forms which pass each of the visual and chemical composition inspections (have no unacceptable defects) are accepted by passing to the 6 o'clock or lowermost position of the drum 32 where there is an absence of vacuum at the outer surface of the drum 32. The “good” tablets fall and are defected by the deflectors 70 into a “good dosage form” bin located at the end of the path of conveyance below the drum 32.

Referring again to FIG. 2, the upper rotating drum 30 rotates in a clockwise direction an array or rows of dosage forms so that they travel along a first circular segment or path which extends from the 12 o'clock position of the drum 30 to the first or upper inspection or vision station at which a row of the dosage forms have a predetermined position but random and unknown orientation for machine vision inspection at a 3 o'clock position of the drum 30 for inspection by the first imaging assembly. Then the upper rotating drum 30 rotates from the 3 o'clock position to a 4:30 position of the drum 30 for inspection by the chemical imaging assembly. Subsequently, the vacuum transfer drum 30 of the transfer subsystem rotates the vacuum-held dosage forms after inspection by the chemical imaging assembly so that the inspected dosage forms travel along the first circular path to a 6 o'clock position of the drum 30 for transfer (by the lack of vacuum acting upon the tablets in this position) to the lower rotating drum 32 at its 12 o'clock position. From the 12 o'clock position, the drum 32 rotates counterclockwise to its 9 o'clock position at the second vision station for further machine vision inspection by the second imaging assembly. Finally, after inspection at the 9 o'clock position, the lower drum 32 rotates the vacuum-held dosage forms to the 6 o'clock position where any “defective” or “bad” dosage forms fall off the drum 32 at the reject station into a “bad” bin. As previously mentioned, if a dosage forms are not defective, the “good” dosage forms fall at the 6 o'clock position of the drum 32 at which the dosage forms are no longer held on the drum 32 by a vacuum and are deflected by its deflector 70 to the “good” bin.

As illustrated in FIG. 4, the vacuum transfer drum 30 (as well as the vacuum transfer drum 32) has a plurality of axially extending, apertured transfer strips 57 bonded onto the outer surface of its cylindrical tube or member 55, in which dosage forms, such as tablets (in 8 columns in FIG. 4) are received and retained by vacuum in the depressions 58. The depressions 58 in the strips 57 are spaced at intervals to provide a “metering effect” which allows the proper spacing of dosage forms for inspection and rejection of defective or “bad” dosage forms or possible sorting of the dosage forms based on detected chemical composition. This enables optical inspection of the viewable top or bottom surfaces of the tablets at the first and second vision stations by the first imaging assembly (i.e. the camera assembly 110 and the upper and lower light illumination devices 114 and 116, respectively) and the second imaging assembly (i.e. the camera assembly 112 and the upper and lower light illumination devices 118 and 120), respectively. This also enables chemical inspection or imaging of a viewable surface of the tablets at the chemical composition station by the chemical imaging assembly. Typically, such vacuum transfer drums 30 and 32 are capable of transferring dosage forms between stations while maintaining a predetermined position and vertical orientation of the array of dosage forms.

The optical images provided by the upper and lower imaging assemblies are processed by at least one processor (FIG. 2) to determine visual defects such as defects in shape, integrity, aspect, coating, engraving and contamination located at the viewable surfaces of the tablets. Text recognition may be implemented by the processor to provide optical character recognition capability to the system 10 so alphanumeric characters in the code imprints can be recognized to determine if the code imprint is defective or not. A dosage form is deemed to be defective if the code imprint is either defective or nonexistent.

The processor (or a processor separate from the processor of FIG. 2) spectrally processes chemical imaging data or spectral images from the chemical imaging assembly and reference data. The reference data includes a first set of reference data obtained by chemically imaging a first surface of a reference dosage form having a known good imprint on the first surface and having a known desired chemical composition. The reference data also may include a second set of reference data obtained by chemically imaging a second surface of the reference dosage form opposite the first surface of the reference dosage form.

As described in greater detail hereinbelow, visual defect detection in each region of each surface can be conducted by first running several image processing algorithms and then analyzing the resultant pixel brightness values. Groups of pixels whose brightness values exceed a preset threshold are flagged as a “bright defect”, while groups of pixels whose brightness values lie below a preset threshold are flagged as a “dark defect”. Different image processing techniques and threshold values are often needed to inspect for bright and dark defects, even within the same surface region.

Each of the illuminating devices 114, 116, 118 and 120 preferably comprise an LED emitter including at least one and preferably a plurality of rows of LED emitter elements serving to emit radiation in the visible light range. A pair of devices 114 and 116 or 118 and 120 is provided at each vision station to substantially eliminate shadowed code imprints. The illuminating devices may be linear light illuminating devices comprising an array of LEDs and available from CCS, Inc. of Kyoto, Japan.

Each of the illuminating devices 124 and 126 may preferably comprise one or more adjustable halogen or other types of lamps for emitting radiation in the light range of interest such as near-infrared. A plurality of rows of emitter elements may be provided.

Each of the camera assemblies 110 and 112 typically includes an optical or optoelectronic device for the acquisition of images (for example a camera or telecamera) which has an image plane which can be, for example, an electronic sensor (CCD, CMOS). The camera assemblies 110 and 112 may include a high resolution digital telecamera, having an electronic sensor with individual pixels of lateral dimensions equal to or less than one or more microns. Such camera assemblies may comprise cameras which generate images or image data and which are available from Point Grey Research Inc. of Vancouver, British Columbia, Canada.

The camera subsystem or assembly 122 typically includes image gathering optical elements, focal plane array imaging detectors and an imaging spectrometer or spectrograph. Such a camera assembly generates spectral images or chemical imaging data and is available from EVK DI Kerschhagg GmbH of Raaba, Austria.

Lenses used on each camera assembly 110 and 112 operate in the visible wavelength range and are particularly suited for use with cameras capable of high resolution image acquisition, wherein the individual image point (pixel) is very small, and wherein the density of these pixels is very high, thereby enabling acquisition of highly detailed images of the dosage forms in a row of such dosage forms.

Lenses and other optical elements on each camera assembly or subsystem 122 typically operate in the near-infrared or other wavelength range needed for spectroscopic or chemical imaging.

Each image acquired visually will comprise a high numbers of pixels, each of which contains a significant geometric datum based the high performance of the lens operating in the visible wavelength range, thereby being particularly useful for assessing various types of code imprints as well as the dimensions of the dosage forms viewed by the lens. The high level of detail provided by the individual pixels of the cameras enables, after suitable processing of each image, an accurate determination of the code imprints as well as the outline of the dosage forms to be made, improving the efficiency of “edge detection” machine vision algorithms, which select, from a set of pixels making up an image, those pixels that define the border of the code imprints and dosage forms depicted, and thereby to establish the spatial positioning and the size of the code imprints and the dosage forms as well as other features on the imaged surfaces of the dosage forms.

Spectral data obtained with the NIR camera assembly or subsystem 122 may be based on hyperspectral imaging. The subsystem 122 may be based on push-broom technology and may have a field programmable gate array (FPGA). The spectral data obtained with the subsystem 122 may be processed or analyzed by way of univariate or multivariate data analysis (MVDA) containing principal component analysis (PCA) and partial least squares regression (PLS). Spectral data filtering and preprocessing routines may be performed. Such preprocessing may include intensity calibration, normalization or derivation etc. Such preprocessing may occur in the FPGA of the camera subsystem 122.

Consequently, the system of FIGS. 2, 5 and 6 offers a significant improvement in the accuracy of images in any type of application based on machine vision and chemical imaging or viewing, in particular in the field of optical metrology, these being dimensional and chemical measuring of dosage forms having code imprints, without contact, of dosage forms, for example manufactured medicinal tablets.

Pencil light beams from emitters and associated sensors, as well as one or more proximity sensors 33 (FIGS. 2, 5 and 6), may be provided to generate the signals for the system controller to monitor the progress of tablets as they are conveyed. Also, feedback signals from sensors associated with the various drivers of the system may be used by the system controller to monitor the progress of tablets as they are being conveyed. Each pencil light beam is associated with a small control unit or hardware trigger or sensor that produces an electrical pulse when a light beam is blocked. The pulse may be referred to as a “trigger.”

In general, when setting up for inspecting a new dosage form, whether a tablet or a capsule, the user chooses surface “features” such as code imprint of the dosage form to be inspected or measured via the user interface. The types of features include design or code imprint dimensions. For most features, the user chooses a region of the dosage form where the measurements will be made, including chemical composition measurements, a nominal value of the measurement, and plus and minus tolerances. For some features, the measurement region is the whole dosage form surface.

More particularly, in creating a template, a gold or master or reference dosage form or a row of such dosage forms with known good dimensions, and a known desired chemical composition and surface features or code imprints and without defects is conveyed in the system 10 after which the particular dosage form is named. After the dosage form or row of such dosage forms has traveled the length of the path, one or more images, including a spectral image of the dosage form, is displayed on a display of the system. Preferably, the reference dosage form is conveyed in the system twice so that each surface is chemically imaged.

Software locates and defines several regions of interest on the dosage form and inspects those regions using any number of customizable tools for user-defined defects. In order to allow the system 10 to be able to locate and recognize a wider variety of defects, exterior surfaces of the dosage forms are illuminated from a variety of angles including top side and bottom side angles (FIGS. 2 and 5) as previously described.

### Data/Image Processor for the Detection of Surface Defects and/or Code Imprints on Dosage Forms

The vision subsystems for the embodiment of the invention described above and further described below are especially designed for the inspection of the viewable surfaces of manufactured dosage forms such as pharmaceutical tablets. The processing of dosage form images or resulting data to detect defective dosage forms including dosage forms having defective or nonexistent code imprints can be performed as follows.

### Detection of Dosage Form Defects such as Chips, Cracks and Perforations

The detection of many defective code imprints and surface dents, chips or cracks typically relies on the alteration of the angle of reflected light caused by code imprints as well as a surface deformation on the inspected dosage form. Light which is incident on a surface code imprint or dent will reflect along a different axis than light which is incident on a non-deformed section.

There are generally two ways to detect such 3-D code imprints or dents using this theory. One option is to orient the light source so that light reflected off the dosage form exterior is aimed directly into the camera aperture. Light which reflects off a code imprint or dented or cracked region will not reflect bright background. Alternatively, the light source can be positioned with a shallower angle to the dosage form. This will result in a low background illumination level with code imprints or dents appearing as well deemed origin spots on the image.

Detecting perforations uses both of the principles outlined above. The task is much simpler however, as the region containing the defect is completely non-reflective. Therefore, perforations are visible as dark spots on surfaces illuminated by either shallow or steep angle illumination.

Because the dosage form to be viewed is essentially at a pre-defined location but unknown orientation when the images are acquired, the software to locate dosage forms and their orientation and to identify regions of interest use preset visual clues.

Defect detection in each region of interest is typically conducted by first running several image processing algorithms and then analyzing the resultant pixel brightness values. Groups of pixels whose brightness values exceed a preset threshold are flagged as a “bright defect,” while groups of pixels whose brightness values lie below a preset threshold are flagged as a “dark defect.” Different image processing techniques and threshold values are often needed to inspect for bright and dark defects, even within the same dosage form region.

Previously locating the dosage forms in the image may be accomplished by running a series of linear edge detection algorithms. These algorithms use variable threshold, smoothing and size settings to determine the boundary between a light and dark region along a defined line. These variables are not generally available to the user, but are hard-coded into the software, as the only time they will generally need to change is in the event of large scale lighting adjustments.

Once the dosage form has been located in the image, a framework of part regions is defined using a hard-coded model of the anticipated dosage form shape and surface designs such as code imprints. Each of these regions can be varied in length and width through the user interface in order to adapt the software to varying dosage form sizes.

Once the regions have been defined, a buffer distance is applied to the inside edges of each region. These buffered regions define the area within which the defect searches will be conducted. By buffering the inspection regions, edge anomalies and non-ideal lighting frequently found near the boundaries are ignored. The size of the buffers can be independently adjusted for each region as part of the standard user interface and is saved in a dosage form profile.

There are two general defect detection algorithms that can be conducted in each region. These two algorithms are closely tied to the detection of code imprints, dents and perforations, respectively, as discussed above. More generally, however, they correspond to the recognition of a group of dark pixels on a bright background or a group of bright pixels on a dark background.

Although there may be only two defect detection algorithms used across all the regions on the viewable dosage form, the parameters associated with the algorithm can be modified from region to region. Additionally, the detection of dark and/or bright defects can be disabled for specific regions. This information is saved in the dosage form profile.

The detection of dark defects may be a 6 step process.

1. Logarithm: Each, pixel brightness value (0-255) is replaced with the log of its brightness value. This serves to expand the brightness values of darker regions while compressing the values of brighter regions, thereby making it easier to find dark defects on a dim background.

2. Sobel Magnitude Operator: The Sobel Operator is the derivative of the image. Therefore, the Sobel Magnitude is shown below:

$${S}_{M} = \sqrt{{( \frac{\partial f}{\partial x} )}^{2} + {( \frac{\partial f}{\partial y} )}^{2}}$$

although it is frequently approximated as follows:

$${S}_{M} = \frac{\frac{\partial f}{\partial x} + \frac{\partial f}{\partial y}}{2}$$

The Sobel Magnitude Operator highlights pixels according to the difference between their brightness and the brightness of their neighbors. Since this operator is performed after the Logarithm filter applied in step 1, the resulting image will emphasize dark pockets on an otherwise dim background. After the Sobel Magnitude Operator is applied, the image will contain a number of bright ‘rings’ around the identified dark defects.

3. Invert Original Image: The original image captured by the camera is inverted so that bright pixels appear dark and dark pixels appear bright. This results in an image with dark defect areas appearing as bright spots.

4. Multiplication: the image obtained after step 2 is multiplied with the image obtained after step 3. Multiplication of two images like this is functionally equivalent to performing an AND operation on them. Only pixels which appear bright appear in the resultant image. In this case, the multiplication of these two images will result in the highlighting of the rings found in step two, but only if these rings surround a dark spot.

5. Threshold: All pixels with a brightness below a specified value are set to OFF while all pixels greater than or equal to the specified value are set to ON.

6. Fill in Holes: The image obtained after the completion of steps 1-5 appears as a series of ON-pixel rings. The final step is to fill in all enclosed contours with ON pixels.

After completing these steps, the resultant image should consist of pixels corresponding to potential defects. These bright blobs are superimposed on areas that originally contained dark defects.

The detection of bright defects may be a two-step process.

1. Threshold: A pixel brightness threshold filter may be applied to pick out all saturated pixels (greyscale255). A user-definable threshold may be provided so values lower than 255 can be detected.

2. Count Filter: A count filter is a technique for filtering small pixel noise. A size parameter is set (2, 3, 4, etc.) and a square box is constructed whose sides are this number of pixels in length. Therefore, if the size parameter is set to 3, the box will be 3 pixels by 3 pixels. This box is then centered on every pixel picked out by the threshold filter applied in step 1. The filter then counts the number of additional pixels contained within the box which have been flagged by the threshold filter and verifies that there is at least one other saturated pixel present. Any pixel which fails this test has its brightness set to 0. The effect of this filter operation is to blank out isolated noise pixels.

Once these two steps have been completed, the resultant binary image will consist of ON pixels corresponding to potential defects. Furthermore, any “speckling” type noise in the original image which would have results in an ON pixel will have been eliminated leaving only those pixels which are in close proximity to other pixels which are ON.

After bright and/or dark defect detection algorithms have been run in a given region, the resultant processed images are binary. These two images are then OR'ed together. This results in a single image with both bright and dark defects.

The software now counts the number of ON pixels in each detected defect. Finally, the part may be flagged as defective if either the quantity of defect pixels within a given connected region is above a user-defined threshold, or if the total quantity of defect pixels across the entire dosage form is above a user-defined threshold.

Each of the first and second vision stations may include a three-dimensional imaging subsystem or sensor such as a confocal or triangulation-based subsystem or sensor to obtain 3D images, information or data. The processor processes the 3D data to obtain dimensional or design information related to the dosage form. The image data is both acquired and processed under control of the system controller in accordance with one or more control algorithms. The data from the sensors are processed for use with one or more measurement algorithms to thereby obtain dimensional or design information about the top and bottom surfaces of the dosage forms.

Each confocal or triangulation-based subsystem or assembly typically includes a confocal or triangulation-based sensor, respectively, having a laser for transmitting a laser beam incident on the dosage form from a first direction to obtain reflected laser beams and at least one detector (and preferably two detectors) positioned with respect to the laser beam incident on the dosage form. The sensor is disposed adjacent the dosage form to illuminate the dosage form with the beam of laser energy. Analog signals from the detectors are processed to obtain digital signals or data which can be processed by the processor.

Certain implementations of the invention comprise computer processors which execute software instructions which cause the processors to perform at least one step of an algorithm or method of at least one embodiment of the invention. For example, one or more data processors may implement the methods described herein by executing software instructions in a program memory accessible to the processors. At least one embodiment of the invention may also be partially provided in the form of a program product. The program product may comprises any medium which carries a set of computer-readable signals comprising instructions which, when executed by a data processor, cause the data processor to execute at least one step of the method. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, EPROMS, flash RAM, or the like. The software instructions may be encrypted or compressed on the medium.

Where a component (e.g. software, a processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of inspecting dosage forms having code imprints and sorting the inspected dosage forms, the method comprising:
providing reference data including a first set of reference data obtained by chemically imaging a first surface of a reference dosage form having a known good code imprint on the first surface and having a known desired chemical composition;
consecutively feeding and transferring unpackaged dosage forms having code imprints and random orientations so that the dosage forms travel on a path which extend from a dosage form loading station and through at least one inspection station including a chemical composition station wherein a first surface of each dosage form is viewable at the chemical composition station;
chemically imaging the first surface of each dosage form located at the chemical composition station to obtain a first set of chemical imaging data;
processing the chemical imaging data and the reference data including the first set of reference data to detect inspected dosage forms having chemical compositions different from the desired chemical composition; and
sorting the inspected dosage forms based on the at least one inspection at the at least one inspection station.

2. The method as claimed in claim 1, wherein the inspected dosage forms are solid dosage forms intended for oral use.

3. The method as claimed in claim 2, wherein the solid dosage forms are tablets.

4. The method as claimed in claim 1, wherein the inspected dosage forms are imprinted by at least one of embossing, debossing, engraving and imprinting with ink.

5. The method as claimed in claim 1, wherein the code imprints include an alphanumeric character.

6. The method as claimed in claim 1, wherein the step of consecutively feeding and transferring includes the step of applying a vacuum to the inspected dosage forms.

7. The method as claimed in claim 1, wherein only the first surface of each inspected dosage form is viewable at the chemical composition station.

8. The method as claimed in claim 1, wherein each dosage form to be inspected at the chemical composition station has an unknown orientation.

9. The method as claimed in claim 8, wherein a second surface of each dosage form is viewable at a second inspection station and wherein each dosage form to be inspected at the second inspection station has an orientation opposite the unknown orientation at the chemical composition station.

10. The method as claimed in claim 1, wherein the dosage forms are consecutively fed and transferred in rows.

11. The method as claimed in claim 1, wherein the path includes at least one curved segment.

12. The method as claimed in claim 1, wherein the first surface of the reference dosage form is chemically imaged at the chemical composition station.

13. The method as claimed in claim 1, wherein the reference data includes a second set of reference data obtained by chemically imaging a second surface of the reference dosage form opposite the first surface of the reference dosage form and wherein the second set of reference data is processed during the step of processing.

14. The method as claimed in claim 13, wherein the second surface of the reference dosage form is chemically imaged at the chemical composition station.

15. The method as claimed in claim 1, wherein the step of sorting includes the step of directing dosage forms identified as having an unacceptable chemical composition to a defective dosage form area.

16. A system for inspecting dosage forms having code imprints and sorting the inspected dosage forms, the system comprising:
a storage for storing reference data including a first set of reference data obtained by chemically imaging a first surface of a reference dosage form having a known good code imprint on the first surface and having a known desired chemical composition;
a feeder and transfer subsystem to consecutively feed and transfer unpackaged dosage forms having code imprints and random orientations so that the dosage forms travel on a path which extend from a dosage form loading station and through at least one inspection station including a chemical composition station wherein a first surface of each dosage form is viewable at the chemical composition station;
a chemical imaging assembly to chemically image the first surface of each dosage form located at the chemical composition station to obtain a first set of chemical imaging data;
at least one processor to process the chemical imaging data and the reference data including the first set of reference data to detect inspected dosage forms having chemical compositions different from the desired chemical composition;
at least one dosage form sorter to sort the inspected dosage forms based on the at least one inspection at the at least one inspection station; and
a system controller coupled to the subsystem, the imaging assembly, the at least one processor and the at least one dosage form sorter for controlling the sorting based on the at least one inspection.

17. The system as claimed in claim 16, wherein the inspected dosage forms are solid dosage forms intended for oral use.

18. The system as claimed in claim 17, wherein the solid dosage forms are tablets.

19. The system as claimed in claim 16, wherein the inspected dosage forms are imprinted by at least one of embossing, debossing, engraving and imprinting with ink.

20. The system as claimed in claim 16, wherein the code imprints include an alphanumeric character.

21. The system as claimed in claim 16, wherein only the first surface of each inspected dosage form is viewable at the chemical composition station.

22. The system as claimed in claim 16, wherein each dosage form to be inspected at the chemical composition station has an unknown orientation.

23. The system as claimed in claim 22, wherein a second surface of each dosage form is viewable at a second inspection station and wherein each dosage form to be inspected at the second inspection station has an orientation opposite the unknown orientation at the chemical composition station.

24. The system as claimed in claim 16, wherein the dosage forms are consecutively fed and transferred in rows.

25. The system as claimed in claim 16, wherein the path includes at least one curved segment.

26. The system as claimed in claim 16, wherein the first surface of the reference dosage form is chemically imaged at the chemical composition station.

27. The system as claimed in claim 16, wherein the reference data includes a second set of reference data obtained by chemically imaging a second surface of the reference dosage form opposite the first surface of the reference dosage form and wherein the second set of reference data is processed by the processor.

28. The system as claimed in claim 27, wherein the second surface of the reference dosage form is chemically imaged at the chemical composition station.

29. The system as claimed in claim 24, wherein the subsystem includes a vibration transfer plate having a plurality of spaced apart grooves for moving lines of the dosage forms along the path.

30. The system as claimed in claim 24, wherein the subsystem includes at least one vacuum transfer device for conveying rows of the dosage forms at equal intervals to the chemical composition station.

31. The system as claimed in claim 16, wherein the at least one dosage form sorter directs dosage forms identified as having an unacceptable chemical composition to a defective dosage form area.
